(19) United States
(12) Patent Application Publication
(10) Pub. No.: US 2010/0143051 A1
(43) Pub. Date: Jun. 10, 2010

(54) BALL RACEWAY MILLING DEVICE, TOOL HAVING A BALL RACEWAY MILLING DEVICE, AND METHOD FOR THE APPLICATION OF A BALL RACEWAY MILLING DEVICE

(75) Inventor: Bozkurt Lutfi, Winterlingen (DE)

Correspondence Address: BURR & BROWN, PO BOX 7068, SYRACUSE, NY, 13261-7068, US

(73) Assignee: GUEHRING OHG, Albstadt (DE)

(21) Appl. No.: 12/593,803

(22) PCT Filed: Mar. 25, 2008
(86) PCT No.: PCT/DE2008/000460

§ 371 Date: Feb. 17, 2010

(30) Foreign Application Priority Data
Mar. 23, 2007 (DE) 10 2007 014 575.8
Jul. 13, 2007 (DE) 10 2007 033 056.3

(51) Int. Cl. B23C 5/10; B23C 5/28

(52) U.S. Cl. 407/11; 407/34; 409/234; 409/131

(57) ABSTRACT

The invention relates to a ball raceway milling device (3) having a milling head (4) on which a cutting edge (6) is arranged. According to the invention, the milling head (4) consists of solid carbide. The invention further proposes a tool system having a ball raceway milling device (3) and a tool holder (2), wherein the ball raceway milling device (3) is shrunk within the tool holder (2). In addition, the invention proposes a method for the application of a ball raceway milling device (3).

The invention relates to a ball raceway milling device according to the preamble of claim 1, a tool system having a ball raceway milling device and a method for the application of a ball raceway milling device to a machine tool.

### PRIOR ART

Ball raceway milling devices have already become known in various embodiments. They are used in particular to produce a ball raceway as is used in homokinetic drive shafts.

In German Laid-Open Specification DE 199 45 360 A1, a ball raceway milling device with two cutting plates is described, in which at least one of the cutting plates is associated with an adjusting device, with the aid of which wear of the cutting edge of this cutting plate can be compensated.

### OBJECT AND ADVANTAGES OF THE INVENTION

The invention is based on the object of improving the production of ball raceways.

This object is achieved by the features of claims 1, 11, 13 and 14.

Advantageous and expedient developments of the invention are specified in the dependent claims.

The invention initially proceeds from a ball raceway milling device, in particular for producing a homokinetic drive shaft, which comprises at least one milling head on which a blade is arranged. The core of the invention lies in that the milling head consists of solid carbide. Solid carbide is particularly resistant, as a result of which the service life of the tool is improved, in particular with respect to wear due to chips which have an abrasive action during a machining process.

In a preferred configuration of the invention, a shank section is attached integrally to the milling head, which shank section thus also consists of solid carbide. The shank section can be designed to be inserted into a tool holder. For example, the shank section is shrink-fitted into a corresponding receiving region of a tool holder. The milling head can also be connected to the tool holder in another manner, for example the milling head can be screwed in. The tool holder can be equipped with an HST interface. This approach means that the ball raceway milling device forms a particularly rigid connection with the tool holder.

In a furthermore preferred configuration of the invention, the shank section of the ball raceway milling device can also be shrink-fitted into an intermediate piece consisting of steel. The intermediate piece consisting of steel is in turn preferably designed for connection with a tool holder. It is also conceivable for the intermediate piece to consist of solid carbide.

Owing to the high rigidity of solid carbide, it is at risk of breakage when exposed to sudden forces. In contrast, steel has a high level of toughness. A combination of a steel shank with a shrink-fitted ball raceway milling device forms a unit which uses both the advantages of the steel and the advantages of the solid carbide.

The milling head can in principle have one or a plurality of cutting plates. These can consist of polycrystalline diamond (PCD), cubic boron nitrite (CBN) or a similar hard material, where appropriate a combination of hard materials. The blades are preferably soldered into the solid carbide head.

In a further particularly preferred configuration of the invention, a section without blades which runs around the circumference is provided on the milling head, which section extends between the end of flutes on the milling head and a chucking shank. This means that the concentricity of a ball raceway milling device can be easily determined, in particular if the circumferential section is cylindrical or has at least one cylindrical portion. Moreover, this section of the milling head which is not disrupted by flutes or blades increases the stability of the milling head, which has an advantageous effect with respect to accuracy.

The circumferential section preferably extends between the end of flutes and a flat bearing face on the milling head, to which the chucking shank is attached. The flat bearing face forms the transition to the chucking shank, in a manner of speaking. When the milling head is in its inserted state, the flat bearing face preferably bears against a corresponding counter bearing face, whereby the milling head can be chucked stably. The section which runs around the circumference is preferably wider than 3 mm, in particular wider than mm. In a preferred exemplary embodiment the circumferential section has a width of more than 5 mm. In principle the width can advantageously be in a range from 5 to 15 mm.

In a further preferred configuration of the invention, a plurality of blades is provided, with each blade being associated with a cooling duct which runs separately from the respectively other cooling ducts, at least in the milling head. This means that each blade can be allocated a separate cooling duct without essentially weakening the milling head. This means that the cooling and lubricating behaviour is much improved. The cooling ducts preferably also run separately in a chucking section which is connected to the milling head. The stability advantages of the separately routed cooling ducts are then also produced in the chucking shank.

In a particularly preferred configuration of the invention, a plurality of cut-outs is provided with blades, with cooling ducts exiting into the cut-outs in such a manner that coolant sprays directly onto a cutting edge of the blade which is arranged in the respective cut-out when coolant is applied. The coolant outlet is preferably created or the coolant route to the outlet is designed in such a manner that when coolant is applied the coolant sprays onto a transition on the cutting edge of the respective blade from a small radius or a chamfer in particular in the end region to a comparatively large radius in the side region. In this manner optimised chip removal can be realised.

In a tool system with a ball raceway milling device as described, an essential aspect lies in that the ball raceway milling device is shrink-fitted into the tool holder. This produces an especially close connection between the ball raceway milling device and the tool holder.

It is particularly preferred if the tool holder and the ball raceway milling device are matched to each other in such a manner that the ball raceway milling device can be easily shrink-fitted in and out. In order to do this, the materials of the ball raceway milling device and the tool holder are to be taken into account and the geometries to be defined correspondingly so that on the one hand a firm fit in the cold state is ensured but on the other hand unshrinking can be carried out by heating the tool holder. Particular attention is to be paid to the geometries if both the tool holder with a socket and the section of the ball raceway milling device which is to be shrink-fitted are for example an intermediate piece consisting of steel.

In order to improve the service life of a tool system consisting of a ball raceway milling device and a tool holder further, it is furthermore proposed to provide the tool holder with a protective covering consisting of a hard layer, for example a solid carbide layer.

### EXEMPLARY EMBODIMENT

An exemplary embodiment of the invention is shown in the drawings and explained in more detail below, giving further advantages and details. In the figures,

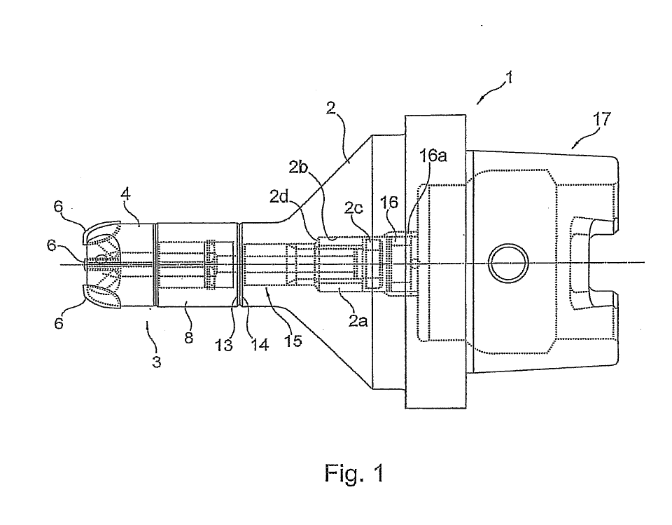

FIG. 1 shows a tool holder with an inserted ball raceway milling device in a side view,

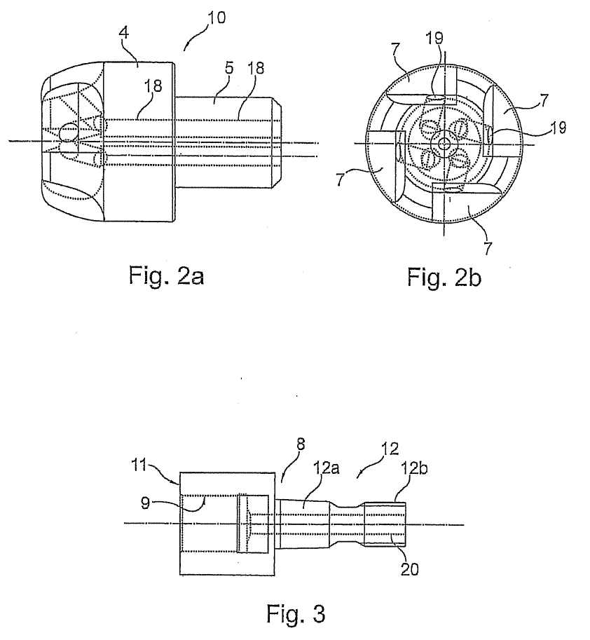

FIGS. 2a and 2b show the milling head in the embodiment of FIG. 1 alone without cutting plates in a side view and a plan view, and

FIG. 3 shows an intermediate piece between the milling head and the tool holder corresponding to the embodiment of FIG. 1 alone in a side view.

FIG. 1 shows a tool system 1 which comprises a tool holder 2 and a ball raceway milling device 3.

The ball raceway milling device 3 consists of a milling head 4, to which a shank 5 is integrally attached (see in particular FIG. 2a). The milling head 4 and the shank 5 consist of solid carbide. Four cutting plates 6 consisting of a hard material, for example CBN or PCD are inserted, for example soldered, into the milling head 4. A chip space 7 is formed in front of the cutting face of each cutting plate 6 (see in particular FIG. 2b). Since the milling head 4 consists of solid carbide, the limiting faces of the chip space consist of solid carbide except for the regions where a respective cutting plate 6 is formed. This means that the milling head is particularly resistant to abrasive wear, for example to chips which are produced and removed via the chip space.

The service life of such a milling head is thereby increased overall.

The shank 5 is shrink-fitted into a bore 9 in an intermediate piece 8.

In order to achieve exact positioning of the milling head with the shank 5 in the intermediate piece 8, the milling head 4 preferably has a ground flat bearing face 10, which bears against an end face 11 of the intermediate piece 8.

The intermediate piece 8 has a projection 12 on which a seat region 12a and an external thread 12b are formed.

The intermediate piece 8 preferably consists of steel. The ball raceway milling device 3 is thereby made out of a particularly resistant solid carbide in a region in which it is exposed to particular wear and of a comparatively tougher material, namely steel, in a section in which a certain toughness is required in order to obtain a lower susceptibility to breakage.

The ball raceway milling device 3 with the intermediate piece 8 can be inserted over the projection 12 and the external thread 12b which is formed there into the tool holder 2 formed for it and screwed there. To this end a sleeve-like component 2a is provided in the tool holder 2, which component sits in a bore 2b in the tool holder 2.

The sleeve-like component 2a has an internal thread which matches the external thread 12b of the projection 12 of the intermediate piece 8. Moreover, the sleeve-like component 2a has a hexagon socket 3c by means of which the sleeve-like component 2a can be rotated using a corresponding tool in order to allow screwing onto the external thread 12b. Another structure for a tool to engage in is of course also possible. The projection is drawn into the tool holder 2 by turning, with flat bearing faces 13, 14 of the intermediate piece 8 and of the tool holder 2 coming to bear. The sleeve-like component 2a is supported against a flank 2d of the bore 2b of the tool holder 2a.

A screw element 16 is provided which sits at the end of the bore 2b, so that the sleeve-like component 2a can be supported at one point when the external thread 12 is screwed down when the ball raceway milling device 3, which preferably enters into a press fit with the tool holder 2 in the region 15, is detached. Moreover, it should be ensured that a tool can reach for example the hexagon socket 2c of the sleeve-like component 2a through the screw element 16. The screw element 16 can for its part have a hexagon socket in order to be able to screw it into the bore 2b with a corresponding tool. To this end the screw element 16 has an external thread 16a, and the corresponding section of the bore 2b has a matching internal thread.

The tool holder preferably has an HST interface.

Furthermore, both the shank 5 and the milling head 4 have a passage 18 to each cooling duct 19 for each cutting plate 6. Cooling medium can thereby be supplied directly to an interface. Correspondingly, passages 20 are provided in the intermediate piece 8 which are configured to match the passages 18 in the shank 5 so that a transition of cooling medium can take place. Both the sleeve-like component 2a and the screw element 16 are open in the centre, whereby cooling medium can be supplied via the interface region 17 of the tool holder to the cutting plates 6 of the ball raceway milling device 3.

### LIST OF REFERENCE SYMBOLS

1 Tool system
2 Tool holder
2a Sleeve-like component
2b Bore
2c Hexagon socket
2d Flank
3 Ball raceway milling device
4 Milling head
5 Shank
6 Cutting plate
7 Chip space
8 Intermediate piece
9 Bore
10 Flat bearing face
11 End
12 Projection
12a Seat region
12b External thread
13 Flat bearing face
14 Flat bearing face
15 Flat bearing face
16 Screw element
16a External thread
17 HST interface
18 Passage
19 Cooling duct outlet
20 Passage

1. A ball raceway milling device having a milling head, on which at least one blade is arranged, the milling head consisting of solid carbide.

2. A ball raceway milling device according to claim 1, wherein a shank section is attached integrally to the milling head.

3. A ball raceway milling device according to claim 1, wherein the shank section is shrink-fitted into an intermediate piece consisting of steel.

4. A ball raceway milling device according to claim 1, wherein the shank section is designed to be inserted into a tool holder.

5. A ball raceway milling device according to claim 1, wherein the milling head is provided with a plurality of cutting plates consisting of hard material.

6. A ball raceway milling device according to claim 1, wherein a section without blades which runs around the circumference is provided on the milling head, which section extends between the end of flutes on the milling head and a chucking section.

7. A ball raceway milling device according to claim 6, wherein the circumferential section extends between the end of flutes and a flat bearing face of the milling head, to which a chucking shank is attached.

8. A ball raceway milling device according to claim 6, wherein the circumferential section is cylindrical or comprises a cylindrical portion.

9. A ball raceway milling device according to claim 1, wherein a plurality of blades is provided and each blade is associated with a cooling duct with a cooling duct outlet, which runs separately from the respective other cooling ducts, at least in the milling head.

10. A ball raceway milling device according to claim 1, wherein a plurality of cut-outs are provided with blades, and cooling ducts exit into the cut-outs at cooling duct outlets in such a manner that coolant sprays directly onto cutting edges of the blades which are arranged in the cut-outs when coolant is applied.

11. A tool system having a ball raceway milling device according to claim 1 and a tool holder, wherein the ball raceway milling device is shrink-fitted into the tool holder.

12. A tool system according to claim 11, wherein the tool holder and the ball raceway milling device are matched to each other in such a manner that the ball raceway milling device can be easily shrink-fitted in and out.

13. A tool system having a ball raceway milling device according to claim 1 and a tool holder, wherein the tool holder bears a protective covering consisting of a hard layer.

14. A method for applying a ball raceway milling device to a machine tool, wherein the ball raceway milling device is connected to a tool holder of the machine tool by shrink-fitting.

15. A ball raceway milling device according to claim 3, wherein the intermediate piece is connected to a tool holder.

16. A tool system having a ball raceway milling device according to claim 11 and a tool holder, wherein the tool holder bears a protective covering consisting of a hard layer.

17. A tool system having a ball raceway milling device according to claim 12 and a tool holder, wherein the tool holder bears a protective covering consisting of a hard layer.
